(19) United States
(12) Patent Application Publication
(10) Pub. No.: US 2025/0254251 A1
(43) Pub. Date: Aug. 7, 2025

(54) IMAGE PROCESSING APPARATUS, CONTROL METHOD, AND STORAGE MEDIUM

(71) Applicant: CANON KABUSHIKI KAISHA, Tokyo (JP)

(72) Inventor: KAZUKI SAMO, Kanagawa (JP)

(21) Appl. No.: 19/036,611

(22) Filed: Jan. 24, 2025

(30) Foreign Application Priority Data
Feb. 2, 2024 (JP) 2024-014586

(51) Int. Cl. H04N 1/00

(52) U.S. Cl. CPC H04N 1/00416; H04N 2201/0094

(57) ABSTRACT

An image processing apparatus includes a generation unit configured to generate document data based on a read document, a setting unit configured to enable a correction mark setting which causes a correction mark indicating a trace of a correction made to the document to be included in the document data generated by the generation unit, and a display unit configured to display a setting screen of a setting related to the correction mark setting, wherein, in a case where the setting screen of the setting related to the correction mark setting is displayed by the display unit while the correction mark setting is being enabled, the setting screen of the setting related to the correction mark setting is displayed in a state where a setting value for enabling the correction mark setting is selected.

### BACKGROUND

### Field of the Disclosure

The present disclosure relates to an image processing apparatus, a control method, and a storage medium.

### Description of the Related Art

A single-function reading apparatus (scanner apparatus) and an image reading apparatus (scanner) mounted on a copying machine are provided as apparatuses which generate document data such as electronic documents by optically scanning documents such as paper documents. Recently, mobile terminals have also been usable as document scanners. Hereinafter, these apparatuses are collectively called “reading apparatuses”.

On the other hand, with respect to the documents such as ledger sheets for tax affairs, only paper documents have been approved as “original copies”. However, in recent years, the legal system has been changed along with the progress in the electronic documentation technique, so that electronic documents have also been approved as the original copies if the electronic documents satisfy a predetermined condition. As a condition for approving the electronic documents as original copies, information about a trace which indicates a correction made on documents, e.g., a trace of a correction fluid, (hereinafter, also called “correction mark”), should not be disappeared (i.e., visibility of the correction mark should be retained), when documents having correction marks are converted into electronic documents. Therefore, in order to retain the correction mark, a method for executing a job in a setting which automatically retains correction marks has been provided (Japanese Patent Application Laid-Open No. 2023-112514).

However, through the method discussed in Japanese Patent Application Laid-Open No. 2023-112514, a user may not be able to figure out at what setting value the scan has been executed because the scan is executed in a state where a setting value is automatically changed to a setting value for retaining a correction mark after the user has performed the operation for executing the scan processing.

### SUMMARY

Therefore, the present disclosure is directed to improving the usability when the user scans documents to acquire data which retains correction marks.

An image processing apparatus includes at least one memory that stores a set of instructions, and at least one processor that executes the instructions causing the image processing apparatus to perform operations comprising a generation unit configured to generate document data based on a read document, a setting unit configured to enable a correction mark setting which causes a correction mark indicating a trace of a correction made to the document to be included in the document data generated by the generation unit, and a display unit configured to display a setting screen of a setting related to the correction mark setting, wherein, in a case where the setting screen of the setting related to the correction mark setting is displayed by the display unit while the correction mark setting is being enabled, the setting screen of the setting related to the correction mark setting is displayed in a state where a setting value for enabling the correction mark setting is selected.

Further features of the present disclosure will become apparent from the following description of exemplary embodiments with reference to the attached drawings.

### BRIEF DESCRIPTION OF THE DRAWINGS

FIG. 1 is a diagram illustrating an overall view of an image processing system according to a first exemplary embodiment.

FIG. 2 is a block diagram illustrating a configuration of a multifunction peripheral (MFP) according to the first exemplary embodiment.

FIG. 3 is a diagram illustrating a configuration of an application according to the first exemplary embodiment.

FIGS. 4A to 4F are diagrams illustrating examples of a screen displayed on an operation display unit according to the first exemplary embodiment.

FIG. 5 is a flowchart illustrating an example of processing to be executed when a retain trace of correction fluid button according to the first exemplary embodiment is pressed.

FIGS. 6A to 6C are diagrams illustrating examples of a screen displayed on the operation display unit in a case where a setting for “Retain Trace of Correction Fluid” is enabled according to the first exemplary embodiment.

FIG. 7 is a flowchart illustrating an example of processing for displaying a setting screen according to the first exemplary embodiment.

FIG. 8 is a flowchart illustrating an example of processing for selecting/confirming a transmission address according to the first exemplary embodiment.

FIG. 9 is a diagram illustrating an example of an address book screen according to the first exemplary embodiment.

FIG. 10 is a flowchart illustrating an example of processing executed when scan is started, according to the first exemplary embodiment.

FIGS. 11A to 11C are diagrams illustrating examples of an address book screen and a pop-up screen displayed when scan is started, according to the first exemplary embodiment.

FIGS. 12A and 12B are diagrams illustrating examples of a setting screen according to a second exemplary embodiment.

FIGS. 13A and 13B are diagrams illustrating examples of a setting screen according to a third exemplary embodiment.

FIG. 14 is a diagram illustrating an example of a setting screen according to a fourth exemplary embodiment.

FIG. 15 is a flowchart illustrating an example of processing for displaying a related setting item one-time setting screen according to a fourth exemplary embodiment.

### DESCRIPTION OF THE EMBODIMENTS

Hereinafter, a present disclosure is described in detail with reference to the appended drawings. The embodiments described hereinafter are not intended to limit the contents of the disclosure described in the appended claims, and not all of the combinations of features described in the exemplary embodiments are (essentially) required as the solutions of the present disclosure. Further, in the appended drawings, the same reference numerals are applied to constituent elements identical or similar to each other, and duplicative descriptions thereof are omitted.

### <System Configuration>

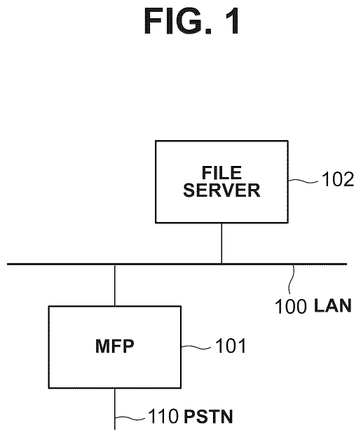

FIG. 1 is a diagram illustrating an example of an image processing system according to a first exemplary embodiment. A multi-function peripheral (MFP) 101 and a file server 102 are communicably connected to each other via a local area network (LAN) 100. The MFP 101 is an example of an image processing apparatus. The file server 102 is an example of a file management apparatus (information processing apparatus). However, the present exemplary embodiment is not limited thereto, and the MFP 101 may be an image processing apparatus including a reading apparatus. Further, the MFP 101 may be a printer having a print function for printing image data on a document. In addition, a printing system of the printer can be an electrophotographic system, an ink jet system, or the other system.

The MFP 101 can specify a folder within the file server 102 as a transmission address to transmit an image data file by using a file transfer protocol. Server Message Block (SMB) and File Transfer Protocol (FTP) can be given as examples of the file transfer protocol. In addition, the MFP 101 can transmit a file not only to the file server 102 but also to a folder within a host personal computer (PC) which is not illustrated. Further, the MFP 101 can transmit image data through an e-mail via a mail server (not illustrated). The MFP 101 is connected to a public switched telephone network (PSTN) 110, and can transmit and receive a facsimile to/from a facsimile machine (not illustrated). The MFP 101 may also be connected to the internet (not illustrated), so that data can be transmitted to the other apparatuses via the internet.

When an address table stored in a device (e.g., the file server 102) included in the image processing system is disclosed, the MFP 101 can acquire and use the address table via the LAN 100.

Although the above-described image processing system includes the MFP 101 and the file server 102, only the MFP 101 can be called an image processing system. Further, a host PC or a management server (not illustrated) may also be included in the image processing system.

### <Hardware Configuration>

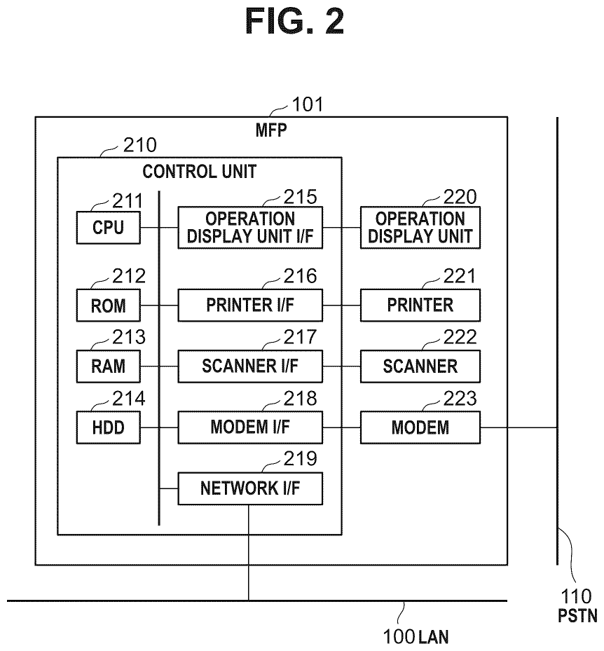

FIG. 2 is a block diagram illustrating an example of the hardware configuration of the MFP 101. The MFP 101 includes a control unit 210, an operation display unit 220, a printer 221, a scanner 222, and a modem 223. The control unit 210 includes a central processing unit (CPU) 211, a read only memory (ROM) 212, a random access memory (RAM) 213, a hard disk drive (HDD) 214, an operation display unit interface (I/F) 215, a printer I/F 216, a scanner I/F 217, a modem I/F 218, and a network I/F 219.

The control unit 210 including the CPU 211 controls operation of the entire MFP 101. The CPU 211 executes various types of control such as reading control and transmission control by reading a control program stored in the ROM 212. The RAM 213 is used as a main memory and a temporary storage area such as a work area used by the CPU 211. Although the one CPU 211 included in the MFP 101 uses one memory, i.e., the RAM 213 or the HDD 214, to execute processing illustrated in the below-described flowcharts, the present exemplary embodiment is not limited thereto. For example, the processing illustrated in the below-described flowcharts may cooperatively be executed by a plurality of CPUs and a plurality of RAMs or HDDs.

The HDD 214 stores image data and various programs. The operation display unit I/F 215 connects the operation display unit 220 to the control unit 210. A liquid crystal display unit and a keyboard having a touch panel function, capable of displaying the information related to the MFP 101 and accepting the operation performed by the user, are arranged on the operation display unit 220.

The printer I/F 216 connects the printer 221 to the control unit 210. Image data to be printed by the printer 221 is transferred from the control unit 210 via the printer I/F 216, and printed on a recording medium by the printer 221.

The scanner I/F 217 connects the scanner 222 to the control unit 210. The scanner 222 generates image data (image file) by reading an image printed on a document, and inputs the image data to the control unit 210 via the scanner I/F 217. The MFP 101 can transmit the image data (image file) generated by the scanner 222 through file transmission or mail transmission.

The Modem I/F 218 connects the modem 223 to the control unit 210. The modem 223 connects the control unit 210 (MFP 101) to the PSTN 110. The modem 223 transmits/receives a facsimile to/from a facsimile machine connected to the PSTN 110.

The network I/F 219 connects the control unit 210 (MFP 101) to the LAN 100. The network I/F 219 transmits image data and information and receives various types of information to/from an external apparatus (such as the file server 102) connected to the LAN 100.

### <Software Configuration>

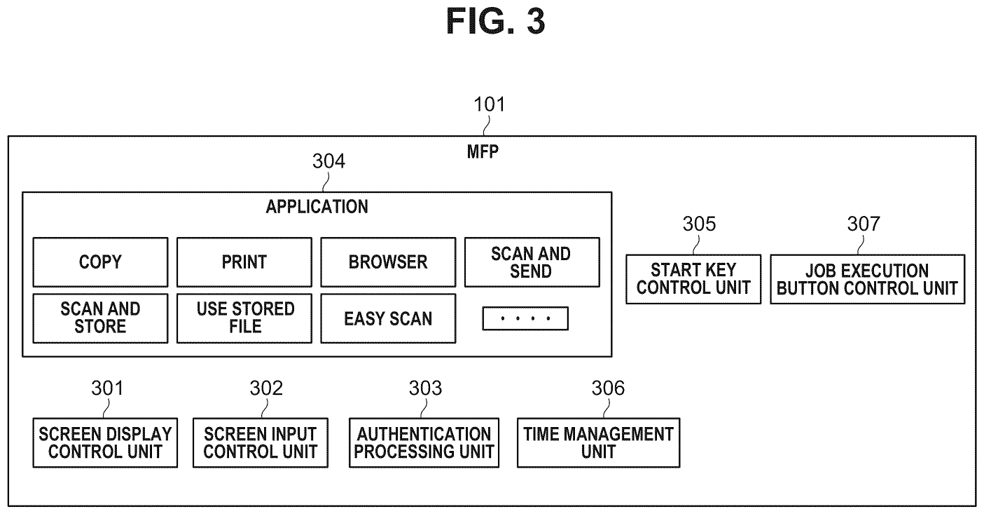

FIG. 3 is a block diagram illustrating an example of a software configuration of the MFP 101. In the present exemplary embodiment, unless otherwise noted, communication between software modules illustrated in FIG. 3 is implemented by the CPU 211 by executing processing according to the program stored in the ROM 212 or the HDD 214. The CPU 211 controls the ROM 212, the RAM 213, the HDD 214, the operation display unit I/F 215, the printer I/F 216, the scanner I/F 217, the modem I/F 218, and the network I/F 219.

The control unit 210 includes a screen display control unit 301, a screen input control unit 302, an authentication processing unit 303, an application 304, a start key control unit 305, a time management unit 306, and a job execution button control unit 307.

The screen display control unit 301 mainly executes screen management of the entire application 304, processing for transmitting screen information to the operation display unit 220, and processing for notifying an event received via the operation display unit 220 to the application 304.

The operation display unit I/F 215 converts the operation received via the operation display unit 220 into a signal, and the screen input control unit 302 receives, analyzes, and converts that signal into an input signal of a format of an event which can be transmitted to the application 304. Then, the screen input control unit 302 transmits the input signal to the screen display control unit 301.

The authentication processing unit 303 displays an authentication screen on the operation display unit 220, and executes user authentication by using authentication information such as an ID and a password input by the user. In a case where the user authentication has succeeded, the authentication processing unit 303 executes log-in processing to let the user log into the MFP 101. When the user inputs a log-out instruction, the authentication processing unit 303 executes log-out processing to let the user log out from the MFP 101.

The application 304 is a group of applications operating on the MFP 101. The CPU 211 runs each of the applications based on the instruction received from the user via the screen input control unit 302. Representative applications of the applications included in the MFP 101 are as follows.

An application program having a “Copy” function, through which the image data which the scanner 222 has generated by reading an image printed on a document is printed by the printer 221.

An application program having a “Print” function, through which the image data is printed by the printer 221 based on a print job received from an external apparatus such as a PC.

An application program having a “Scan and Send” function, through which the image data which the scanner 222 has generated by reading an image printed on a document is transmitted to the outside.

An application program having a “Scan and Save” function, through which the image data which the scanner 222 has generated by reading an image printed on a document is saved in an external memory.

An application program having a “Use Saved File” function, through which the image data saved in the external memory is printed or transmitted to the outside by the printer 221.

An application program having a “Browser” function, through which data within a Web server is browsed, printed, and saved via a Web browser.

An application program having an “Easy Scan” function which limits the “Scan and Send” function to only a part of main settings to allow the user to easily use the “Scan and Send” function.

In addition, the application 304 included in the MFP 101 is not limited to the above-described examples. Further, the application 304 can be added later according to the user's instruction.

The start key control unit 305 detects a press of the start key via the screen input control unit 302, and notifies the application 304 of execution of the start key. The application 304 is notified of execution of the start key and executes a corresponding function.

The time management unit 306 manages the current time after the MFP 101 is activated, and notifies the current time according to an instruction from the start key control unit 305 or the job execution button control unit 307.

According to an instruction from the user, the job execution button control unit 307 executes setting of a function of a corresponding application, and stores the setting in the HDD 214. Further, the job execution button control unit 307 detects a press of a registered job execution button, calls the corresponding application 304, and executes the application 304 with the setting previously registered and stored in the HDD 214.

In addition, the configuration illustrated in FIG. 3 is merely an example, and the present exemplary embodiment is not limited to that example. Part of the configuration in FIG. 3 may be excluded, or another configuration may be added to the configuration in FIG. 3.

In Japan, amendments have been made to the Act on Special Provisions concerning Preservation Methods for Books and Documents Related to National Tax Prepared by Means of Computers (i.e., the Electronic Books Maintenance Act), so that scan data which satisfies a specific condition is approved as legitimate documents. As the specific condition, for example, the scan data has to show recognizable traces of corrections (recognizable correction marks) in a case where corrections are made on the contents (Article 4, paragraph (27)). Therefore, in order to retain the correction marks, a method for executing a job in a setting value for automatically retaining the correction marks has been known.

However, in a case where a job is executed in a state where a setting value is automatically changed to a setting value for retaining the correction marks after the user has performed the operation for executing scan processing, the user may not be able to figure out at what setting value the job has been executed. For example, in a case where the job is executed in a state where the setting value set by the user is automatically changed to a different setting value in order to retain the correction marks, a deliverable acquired through the scan processing is not a deliverable acquired through the scan processing executed with the setting value set by the user. In this case, the user acquires a deliverable (i.e., scan data) of the scan processing executed with the setting value different from the setting value set by the user, so that there is a possibility that the usability is degraded. Further, in a case where a setting value of a setting related to the setting for retaining a correction mark is change by the user when the setting for retaining a correction mark is enabled, the user may not be able to acquire a deliverable (scan data) which retains the correction marks.

Therefore, in the present exemplary embodiment, in a case where the setting for retaining a correction mark is enabled, the image processing apparatus notifies the user of at what setting value the scan processing is to be executed. Specifically, in a case where the setting for retaining a correction mark is enabled, the image processing apparatus displays a setting value of a setting item (a setting item related to the setting for retaining a correction mark) set to retain a correction mark.

In this way, the user can perform the operation for executing a job after figuring out at what setting value the scan processing is to be executed. Therefore, the user is less likely to acquire scan data acquired through the scan processing executed with the setting value different from the setting value the user has figured out, so that the usability can be improved.

Further, in the present exemplary embodiment, in a case where the setting for retaining a correction mark is enabled, the image processing apparatus executes control which prevents a setting value of the setting related to the setting for retaining a correction mark from being changed, if change of that setting value causes the setting for retaining a correction mark to be disabled. In other words, the image processing apparatus executes control which brings a setting value competing with the setting for retaining a correction mark into a non-selectable state. Specifically, in a case where the setting for retaining a correction mark is enabled, the image processing apparatus displays a setting value, whose change causes the setting for retaining a correction mark to be disabled, in a gray-out state. Alternatively, the image processing apparatus hides a setting value whose change causes the setting for retaining a correction mark to be disabled.

With the above-described configuration, a possibility of the user unintentionally changing the setting value for retaining a trace of a correction fluid can be reduced, so that the usability can be improved.

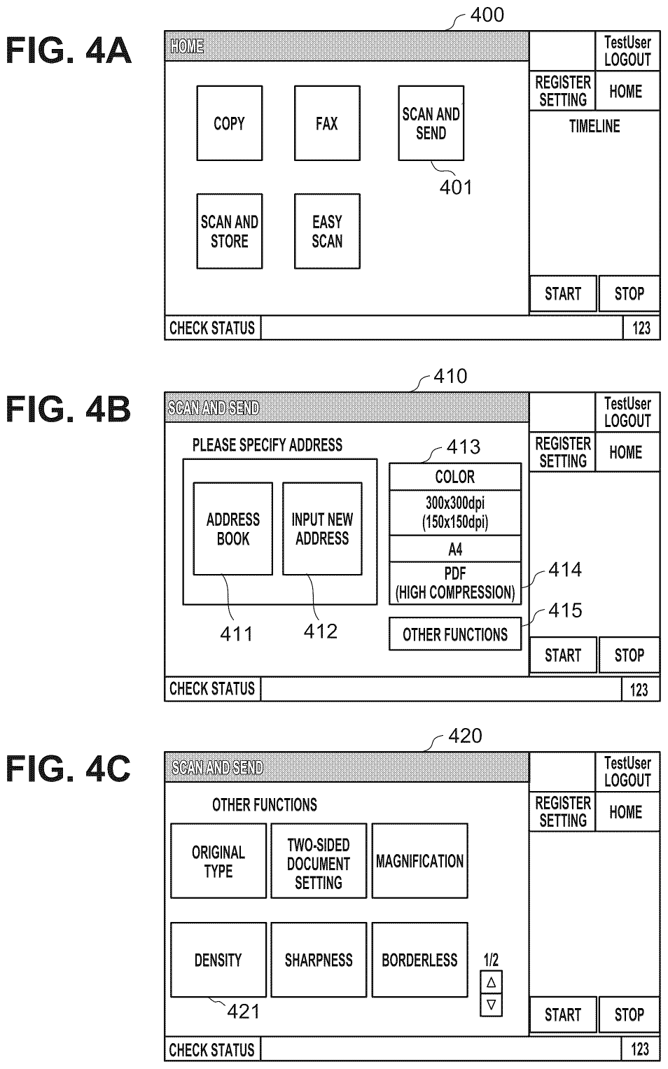

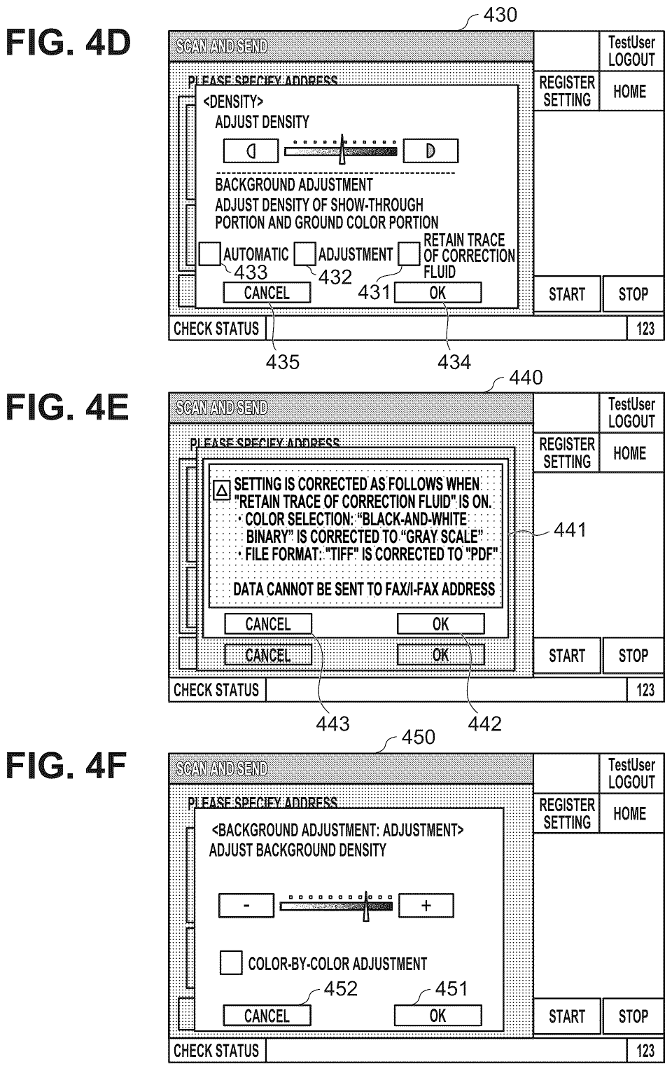

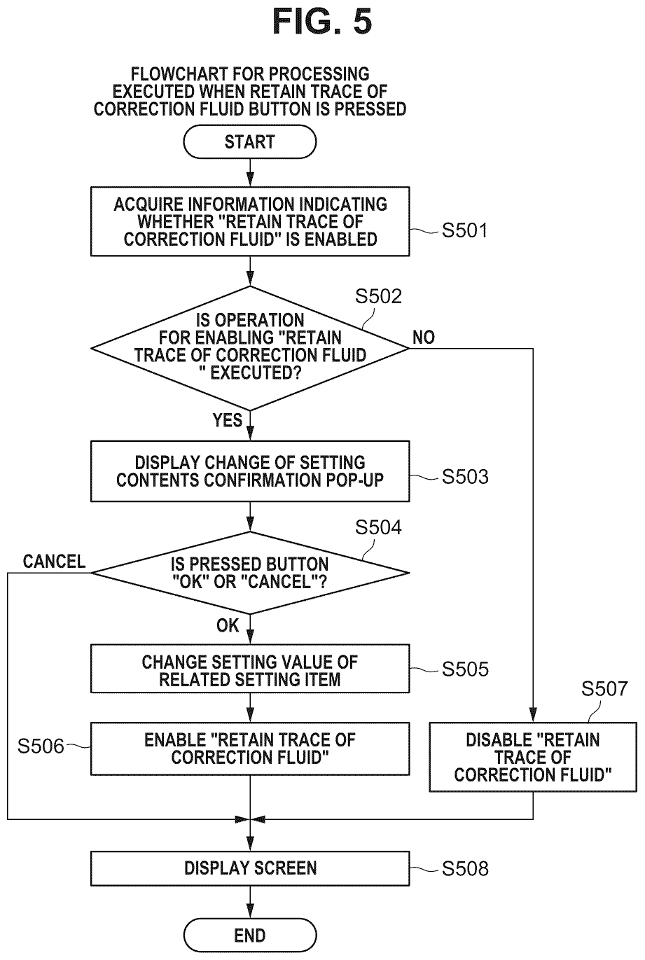

Hereinafter, an example of the processing for changing setting values of a group of setting items related to the setting for retaining a correction mark to specific setting values is described with reference to FIGS. 4A to 4F and FIG. 5. In the present exemplary embodiment, setting items such as a density, a color selection, a file format, and a base color treatment are regarded as a group of related setting items.

### <Operation Screen>

FIGS. 4A to 4F are diagrams illustrating examples of the screen displayed on the operation display unit 220 according to the present exemplary embodiment. The screens illustrated in FIGS. 4A to 4F are displayed by the screen display control unit 301. FIG. 4A illustrates an example of a home (menu) screen 400. Icons which the user selects to use the above-described application 304 are arranged on the home screen 400. The home screen 400 in FIG. 4A is a screen firstly displayed when the MFP 101 is activated, or a screen displayed when the user presses a home button displayed on another screen. In the present exemplary embodiment, a scan and send application is described as an example of the application 304 using the scanner 222.

FIG. 4B illustrates an example of a basic screen of the scan and send application (hereinafter, called “scan and send screen 410”). The scan and send screen 410 in FIG. 4B is displayed on the operation display unit 220 when the user presses a scan and send button 401 displayed on the home screen 400 in FIG. 4A. Address buttons (i.e., an address book button 411 and an input new address button 412), buttons for setting main setting items (i.e., a color selection button 413, a file format button 414, and a sheet selection button), and an other-functions button 415 are arranged on the scan and send screen 410. In the present exemplary embodiment, descriptions are omitted with respect to the button to which attention is not paid.

FIG. 4C illustrates an example of an other-functions screen 420. The other-functions screen 420 in FIG. 4C is displayed on the operation display unit 220 when the other-functions button 415 displayed on the scan and send screen 410 in FIG. 4B is pressed by the user. Buttons (such as a density button 421) for opening respective setting screens are arranged on the other-functions screen 420. In the present exemplary embodiment, descriptions are omitted with respect to the button to which attention is not paid.

FIG. 4D illustrates an example of a density setting screen 430. The density setting screen 430 in FIG. 4D is displayed on the operation display unit 220 when a density button 421 displayed on the other-functions screen 420 in FIG. 4C is pressed by the user. The user can set a density and a background density through the density setting screen 430. Herein, the background density refers to a density of only a base color region excluding a text region and a graphic region. An icon indicating a current density setting, an icon for changing the density setting, a retain trace of correction fluid (i.e., correction mark setting) button 431, a background density adjustment button 432, a background density auto-adjustment button 433, an OK button 434 for closing the screen 430 after reflecting a setting change input to the screen 430, and a cancel button 435 for closing the screen 430 without reflecting the setting are arranged on the density setting screen 430. In the present exemplary embodiment, descriptions are omitted with respect to the button to which attention is not paid. In the present exemplary embodiment, the retain trace of correction fluid button 431 is a button which allows the user to collectively change one or more setting items related to the setting for “Retain Trace of Correction Fluid”. For example, in the present exemplary embodiment, when the retain trace of correction fluid button 431 is pressed, setting values of the related settings, such as the background density, the color selection, the file format, and the base color removal are changed (described below in step S505). In addition, setting values of the background density can be changed through a background adjustment screen 450, the color selection can be changed through a color selection screen 600, and the file format can be changed through a file format screen 610 described below. On the other hand, the base color removal is a setting item which does not have a screen for allowing the user to change a setting value. In the present exemplary embodiment, the retain trace of correction fluid button 431 is arranged on the density setting screen 430, in the vicinity of the related setting item (i.e., background density adjustment button 432) most closely related to the setting for “Retain Trace of Correction Fluid” from among the related setting items, and the button 431 is not arranged on the setting screens for the other setting items. Further, in the present exemplary embodiment, the retain trace of correction fluid button 431 is either in an enabled state or in a disabled state, and the retain trace of correction fluid button 431 is displayed in an emphasized state (e.g., highlighted in yellow color) when the button 431 is enabled.

FIG. 4E illustrates an example of a change of setting contents confirmation pop-up 440. The change of setting contents confirmation pop-up 440 in FIG. 4E is displayed on the operation display unit 220 when the user presses and enables the retain trace of correction fluid button 431 displayed on the density setting screen 430 in FIG. 4D. A message column 441, an OK button 442 for permitting the setting change processing, and a cancel button 443 for rejecting the setting change processing are arranged on the change of setting contents confirmation pop-up 440. In the present exemplary embodiment, descriptions are omitted with respect to the button to which attention is not paid.

FIG. 4F illustrates an example of a background adjustment screen 450. The background adjustment screen 450 in FIG. 4F is displayed on the operation display unit 220 when the user presses the background density adjustment button 432 displayed on the density setting screen 430 in FIG. 4D. A group of icons used for the adjustment of the background density, an OK button 451 for closing the screen 450 after reflecting a change, and a cancel button 452 for closing the screen 450 after rejecting the change are arranged on the background adjustment screen 450. In the present exemplary embodiment, descriptions are omitted with respect to the button to which attention is not paid. In a case where the background density auto-adjustment button 433 displayed on the density setting screen 430 is pressed by the user, the background adjustment screen 450 is not displayed, and the background density is automatically adjusted when a job is executed.

FIG. 5 is an example of a flowchart illustrating processing to be executed when the retain trace of correction fluid button 431 is pressed. The CPU 211 of the MFP 101 executes the processing illustrated in the flowchart in FIG. 5 by reading a program for executing the control module stored in the ROM 212 to the RAM 213 and executing the program. In addition, all or a part of the functions executed in respective steps in FIG. 5 may be executed by hardware such as an application specific integrated circuit (ASIC) or an electronic circuit. A symbol “S” represents “step” in the processing illustrated in the flowchart, and the same can also be said for the other flowcharts described in this specification.

The processing illustrated in the flowchart in FIG. 5 is started when the user presses the retain trace of correction fluid button 431 displayed on the density setting screen 430 in FIG. 4D.

In step S501, the screen display control unit 301 acquires information indicating a current state of the retain trace of correction fluid button 431. Then, the processing proceeds to step S502. Specifically, the screen display control unit 301 acquires the information describing whether the retain trace of correction fluid button 431 is enabled or disabled.

In step S502, the screen display control unit 301 determines whether the information acquired in step S501 indicates that the retain trace of correction fluid button 431 is enabled. In other words, the screen display control unit 301 determines whether the user operation performed on the retain trace of correction fluid button 431 displayed on the density setting screen 430 in FIG. 4D is the operation for enabling the retain trace of correction fluid button 431. Herein, because the retain trace of correction fluid button 431 is either in an enabled (ON) state or in a disabled (OFF) state, a state thereof transitions to another state when the retain trace of correction fluid button 431 is pressed. In other words, in a case where the retain trace of correction fluid button 431 is pressed in a state where the information acquired in step S501 indicates that the retain trace of correction fluid button 431 is disabled, the screen display control unit 301 determines that the user operation performed on the retain trace of correction fluid button 431 is the operation for enabling the retain trace of correction fluid button 431. On the other hand, in a case where the retain trace of correction fluid button 431 is pressed in a state where the information acquired in step S501 indicates that the retain trace of correction fluid button 431 is enabled, the screen display control unit 301 determines that the user operation performed on the retain trace of correction fluid button 431 is the operation for disabling the retain trace of correction fluid button 431. In step S502, in a case where a determination result acquired by the screen display control unit 301 is “YES” (YES in step S502), the processing proceeds to step S503. In a case where a determination result acquired in step S502 is “NO” (NO in step S502), the processing proceeds to step S507.

In step S503, the screen display control unit 301 displays the change of setting contents confirmation pop-up 440 in FIG. 4E on the operation display unit 220, and advances the processing to step S504.

In step S504, the screen display control unit 301 determines whether the OK button 442 is pressed by the user. Specifically, the screen display control unit 301 waits for the user operation (a press of the OK button 442 or the cancel button 443), and determines whether the operation performed by the user is a press of the OK button 442 or the cancel button 443. In a case where the screen display control unit 301 determines that the button pressed by the user in step S504 is the OK button 442 (“OK” in step S504), the screen display control unit 301 closes the change of setting contents confirmation pop-up 440 and advances the processing to step S505. In a case where the screen display control unit 301 determines that the button pressed by the user in step S504 is not the OK button 442 but the cancel button 443 (“CANCEL” in step S504), the screen display control unit 301 closes the change of setting contents confirmation pop-up 440 and advances the processing to step S508. A timing the change of setting contents confirmation pop-up 440 is closed is not limited to the above, and the change of setting contents confirmation pop-up 440 may be closed when the processing proceeds to step S508.

In step S505, the screen display control unit 301 corrects (changes) a setting value of the setting item related to the setting for “Retain Trace of Correction Fluid”. Then, the processing proceeds to step S506. At this time, in the present exemplary embodiment, processing for making the following corrections is executed.
The background density is corrected to “Maximum”.
The color selection is corrected to “Gray Scale” if “Black-and-White Binary” is selected.
The file format is corrected to “PDF” if “TIFF” is selected.
The base color treatment is corrected to “OFF” (a setting screen corresponding to the base color treatment is not provided).

In the present exemplary embodiment, the background density, the color selection, the file format, and the base color treatment described above are corrected. However, a correction target is not limited to these setting items. For example, only a part of the above-described related setting items may be specified as correction targets, or a setting item other than the above-described related setting items may be included in the correction targets. Specifically, only the background density may be specified as a correction target. Alternatively, in addition to the above-described related setting items, a default value may be set to a sharpness (edge enhancement treatment) setting, or a preview display setting for displaying a preview after reading data may be enabled (ON).

In step S506, the screen display control unit 301 enables (turns ON) the setting for “Retain Trace of Correction Fluid”. Then, the processing proceeds to step S508.

In step S507, the screen display control unit 301 disables (turns OFF) the setting for “Retain Trace of Correction Fluid”. Then, the processing proceeds to step S508. In the present exemplary embodiment, the correction processing is not executed on the setting value of the related setting item in a case where the setting for “Retain Trace of Correction Fluid” is disabled. However, the present exemplary embodiment is not limited thereto. For example, when the setting for “Retain Trace of Correction Fluid” is enabled, a setting value before making a change may be retained in the RAM 213. Then, the setting value may be restored when the setting for “Retain Trace of Correction Fluid” is disabled.

In step S508, in a case where the setting for “Retain Trace of Correction Fluid” is enabled (ON), the screen display control unit 301 displays a density setting screen 620 described below. In a case where the setting for “Retain Trace of Correction Fluid” is disabled (OFF), the screen display control unit 301 displays the density setting screen 430 and ends the processing illustrated in this flowchart. Although the density setting screen 620 or 430 is displayed in step S508, the present exemplary embodiment is not limited thereto. For example, the screen displayed in step S508 may be a screen displayed at the time of activation (in the present exemplary embodiment, the home screen 400) or an initial screen of the application (in the present exemplary embodiment, the scan and send screen 410). Alternatively, the screen display control unit 301 may display the above-described screen after displaying a screen for notifying some kind of information to the user, or after accepting the user operation.

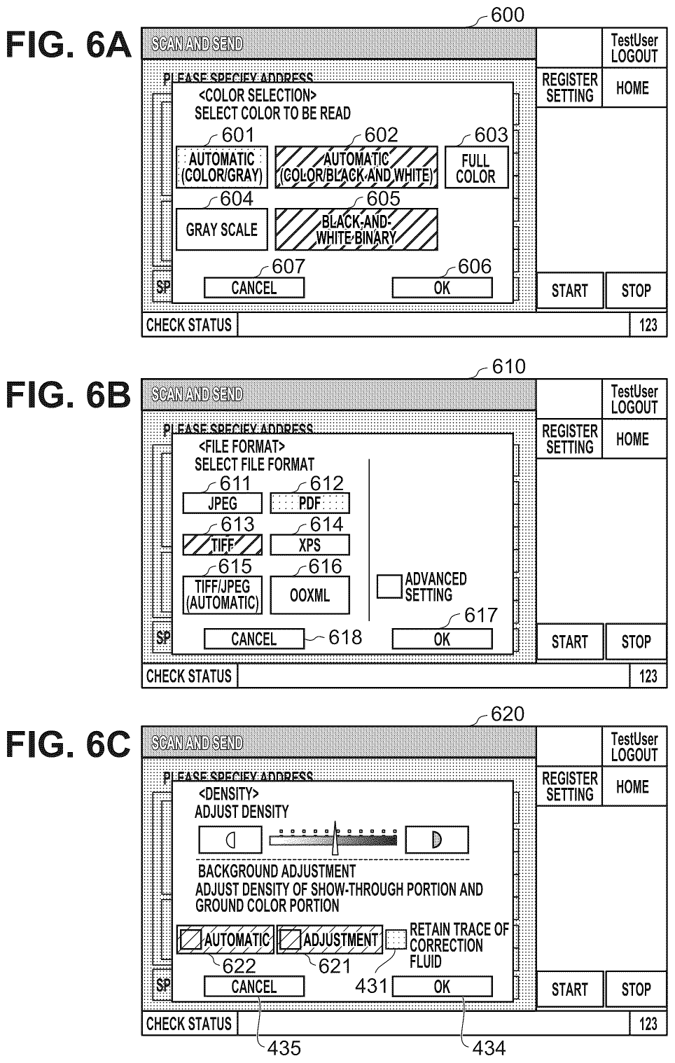

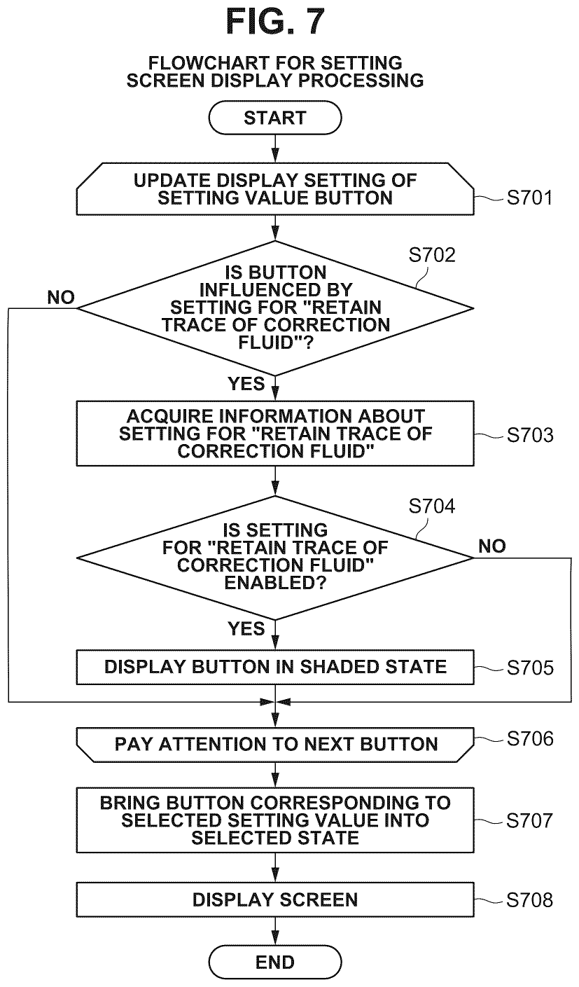

Hereinafter, display processing for displaying setting screens for the scan and send application is described with reference to FIGS. 6A to 6C and FIG. 7. Herein, attention is paid to a setting screen of a setting item influenced by the setting for “Retain Trace of Correction Fluid”. The setting item to be influenced is a setting item related to the setting for “Retain Trace of Correction Fluid”. For example, in the present exemplary embodiment, the color selection (color selection screen 600), the file format (file format screen 610), and the background density (density screen 620) are influenced thereby.

FIGS. 6A to 6C are diagrams illustrating examples of the setting screens of the setting items regarded as correction target candidates whose setting values are corrected in step S505 in a case where the setting for “Retain Trace of Correction Fluid” is enabled (ON). Each of the screens illustrated in FIGS. 6A to 6C is displayed on the operation display unit 220 by the screen display control unit 301.

FIG. 6A illustrates an example of the color selection screen 600. The color selection screen 600 in FIG. 6A is displayed on the operation display unit 220 when the color selection button 413 displayed on the scan and send screen 410 in FIG. 4B is pressed. Color setting value buttons 601 to 605, an OK button 606 for closing the screen 600 after reflecting a setting change input to the screen 600, a cancel button 607 for closing the screen 600 without reflecting the setting change are arranged on the color selection screen 600. Each of the color setting value buttons 601 to 605 is associated with a different setting value. In particular, with respect to the automatic (color/gray) button 601 and the automatic (color/black and white) button 602, the scanner 222 reads a document and detects whether the document is a color document, and a color setting value is reflected when the document is a color document, and another setting value is reflected when the document is not a color document.

On the color selection screen 600, a selected color setting value button is displayed in an emphasized state, and an unusable color setting value button is grayed out and displayed in a shaded state, when the setting for “Retain Trace of Correction Fluid” is enabled (ON). For example, as illustrated in FIG. 6A, while the automatic (color/gray) button 601 is selected, each of the automatic (color/black and white) button 602 and the black and white binary button 605 is displayed in an unusable state.

FIG. 6B illustrates an example of the file format screen 610. The file format screen 610 in FIG. 6B is displayed on the operation display unit 220 when the file format button 414 displayed on the scan and send screen 410 in FIG. 4B is pressed. File format setting value buttons 611 to 616, an OK button 617 for closing the screen 610 after reflecting a setting change input to the screen 610, a cancel button 618 for closing the screen 610 without reflecting the setting change are arranged on the file format screen 610. Each of the file format setting value buttons 611 to 616 is associated with a different setting value. In particular, with respect to the Tagged Image File Format (TIFF)/Joint Photographic Experts Group (JPEG) (automatic) button 615, the scanner 222 reads a document and detects whether the document is a black-and-white binary document, and a setting value for TIFF is reflected when the document is a black-and-white binary document, and a setting value for JPEG is reflected when the document is not a black-and-white binary document. In this case, although the TIFF/JPEG (automatic) button 615 is selectable, the document is read in a JPEG format even if the TIFF/JPEG (automatic) button 615 is selected. Further, in a case where the TIFF/JPEG (automatic) button 615 is selected, the image processing apparatus may notify the user that the document cannot be read in a TIFF format (or the document is read in a JPEG format).

On the file format screen 610, a selected file format setting value button is displayed in an emphasized state, and an unusable file format setting value button is grayed out and displayed in a shaded state, when the setting for “Retain Trace of Correction Fluid” is enabled (ON). For example, as illustrated in FIG. 6B, while a PDF button 612 is selected, a TIFF button 613 is displayed in an unusable state.

FIG. 6C illustrates an example of a density setting screen displayed again when the user presses the retain trace of correction fluid button 431 displayed on the density setting screen 430 to enable (turn on) the setting for “Retain Trace of Correction Fluid”. In FIG. 6C, the retain trace of correction fluid button 431 is displayed in an emphasized state. Further, as illustrated in FIG. 6C, in a case where the background density is not changeable, each of a background density adjustment button 621 and a background density auto-setting button 622 is displayed in a shaded state and cannot be used.

FIG. 7 is an example of a flowchart illustrating display processing for displaying each of the setting screens illustrated in FIGS. 6A to 6C. The CPU 211 of the MFP 101 executes the processing illustrated in the flowchart in FIG. 7 by reading a program for executing the control module stored in the ROM 212 to the RAM 213 and executing the program. In addition, all or a part of the functions executed in respective steps in FIG. 7 may be executed by hardware such as an ASIC or an electronic circuit.

The processing illustrated in the flowchart in FIG. 7 is started when the user presses any one of the color selection button 413, the file format button 414, and the density button 421 displayed on the scan and send screen 410 in FIG. 4B. In addition, a trigger for starting the processing illustrated in the flowchart in FIG. 7 is not limited to the above. For example, the processing illustrated in the flowchart in FIG. 7 may be started in a case where any one of the setting screens in FIG. 6A to 6C is displayed after a previous screen of some sort is closed. Specifically, the processing illustrated in the flowchart in FIG. 7 may be started when the user presses the OK button or the cancel button displayed on the background adjustment screen 450 or the change of setting contents confirmation pop-up 440.

In step S701, the screen display control unit 301 starts updating the display setting of respective buttons displayed on the setting screen. The processing proceeds to step S702 while attention is paid to one button displayed on the setting screen. For example, in a case where the processing illustrated in this flowchart is started when the user presses the color selection button 413, attention is paid to any one of the color setting value buttons 601 to 605 illustrated in FIG. 6A. In the present exemplary embodiment, although attention is not paid to the OK button 606 and the cancel button 607 in step S701, attention may also be paid to these buttons 606 and 607.

In step S702, the screen display control unit 301 determines whether the button to which attention is paid is a button influenced by the setting for “Retain Trace of Correction Fluid”. Herein, a button influenced by the setting for “Retain Trace of Correction Fluid” refers to a button of a setting value which causes the setting for retaining a correction mark to be disabled when any change is made (i.e., a button of a setting value competing with the setting for retaining a correction mark). In step S702, in a case where a determination result acquired by the screen display control unit 301 is “YES” (YES in step S702), the processing proceeds to step S703. In a case where a determination result acquired in step S702 is “NO” (NO in step S702), the processing proceeds to step S706. In the present exemplary embodiment, whether a button to which attention is paid is a button influenced by the setting for “Retain Trace of Correction Fluid” is determined based on Table 1 below. In addition, although the density setting screen 430 is not a screen for changing a setting of the setting item related to the setting for “Retain Trace of Correction Fluid”, the density setting screen 430 includes the buttons influenced by the setting. This is to prevent the density setting screen 430 from transitioning to the background adjustment screen 450 for adjusting the background density, so that the background density adjustment button 432 and the background density auto-adjustment button 433 displayed on the density setting screen 430 are influenced by the setting for “Retain Trace of Correction Fluid”.

TABLE 1

| | | Whether a button is influenced |
|---|---|---|
| Setting | | by the setting for “Retain |
| Screen | Button | Trace of Correction Fluid”. |
| Color | Automatic | Not Influenced |
| Selection | (Color/Gray) | |
| Screen | Automatic | Influenced |
| | (Color/Black | |
| | and White) | |
| | Full Color | Not Influenced |
| | Gray Scale | Not Influenced |
| | Black and | Influenced |
| | White Binary | |
| File | JPEG | Not Influenced |
| Format | PDF | Not Influenced |
| Screen | TIFF | Influenced |
| | XPS | Not Influenced |
| | TIFF/JPEG | Not Influenced |
| | (Automatic) | |
| | OOXML | Not Influenced |
| Density | Automatic | Influenced |
| Setting | Adjustment | Influenced |
| Screen | | |

With respect to the color selection screen 600, the automatic (color/black and white) button 602 and the black and white binary button 605 are the setting value buttons influenced by the setting for “Retain Trace of Correction Fluid”. Then, the rest of the buttons are setting value buttons not influenced by that setting.

In step S703, the screen display control unit 301 acquires the information about a current state of the setting for “Retain Trace of Correction Fluid” from the RAM 213. Then, the processing proceeds to step S704.

In step S704, the screen display control unit 301 determines whether the setting for “Retain Trace of Correction Fluid” acquired in step S703 is enabled (ON). In step S704, in a case where a determination result acquired by the screen display control unit 301 is “YES” (YES in step S704), the processing proceeds to step S705. In a case where a determination result acquired in step S704 is “NO” (in a case where the screen display control unit 301 determines that the setting for “Retain Trace of Correction Fluid” is disabled (OFF)), (NO in step S704), the processing proceeds to step S706.

In step S705, the screen display control unit 301 displays the button to which attention is paid in a shaded state. Then, the processing proceeds to step S706. With respect to the color selection screen 600, for example, the processing proceeds to step S705 in a case where attention is paid to the automatic (color/black and white) button 602 and the black and white binary button 605. Then, in step S705, each of the buttons 602 and 605 is displayed in the shaded state. In the present exemplary embodiment, the unusable button is displayed in a shaded state to the user. However, the present exemplary embodiment is not limited thereto. In a case where a button cannot be used, for example, the button may not be displayed on the screen (the button may be hidden). Alternatively, instead of changing a display state of the unusable button on the setting screen, a message describing that the button is not usable may be displayed on the screen when the user presses the button.

In step S706, in a case where a next button on which the processing in steps S701 to S706 has not been executed is present in the setting screen, the screen display control unit 301 pays attention to that button, and advances the processing to step S701. In a case where the next button is not present, the processing proceeds to step S707.

In step S707, the screen display control unit 301 acquires a currently selected setting value from the RAM 213, and brings a button corresponding to that setting value into a selected state. For example, the automatic (color/gray) button 601 is brought into a selected state in FIG. 6A, and the PDF button 612 is brought into a selected state in FIG. 6B.

In step S708, the screen display control unit 301 displays the setting screen corresponding to any one of the color selection button 413, the file format button 414, and the density button 421 pressed when the processing is started, and ends the processing illustrated in this flowchart. For example, in a case where the user has pressed the color selection button 413 to start the processing in this flowchart, the color selection screen 600 is displayed in step S708.

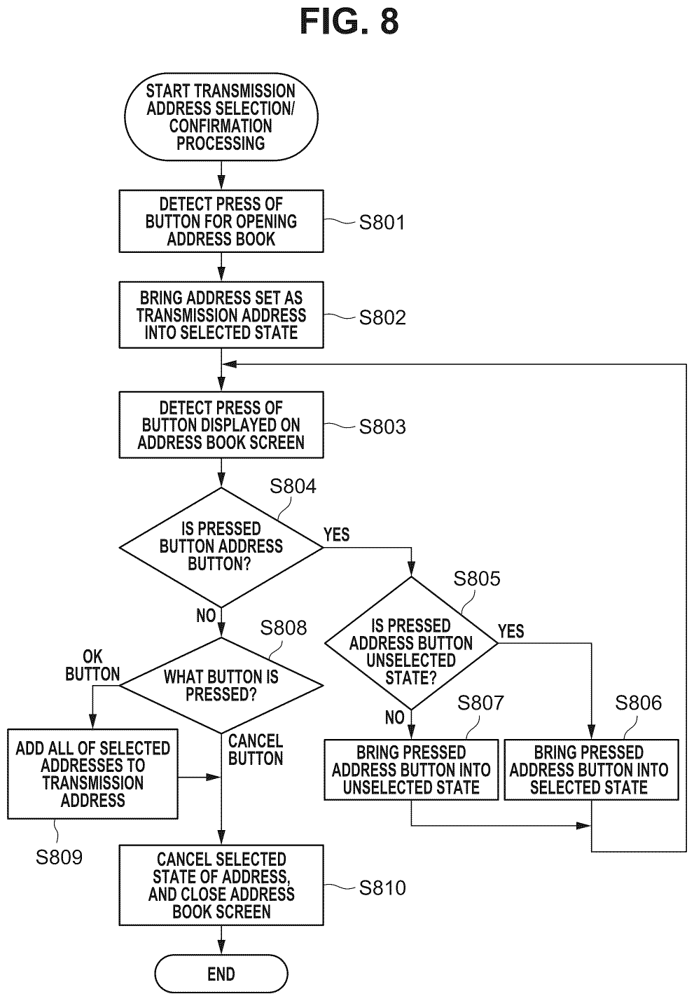

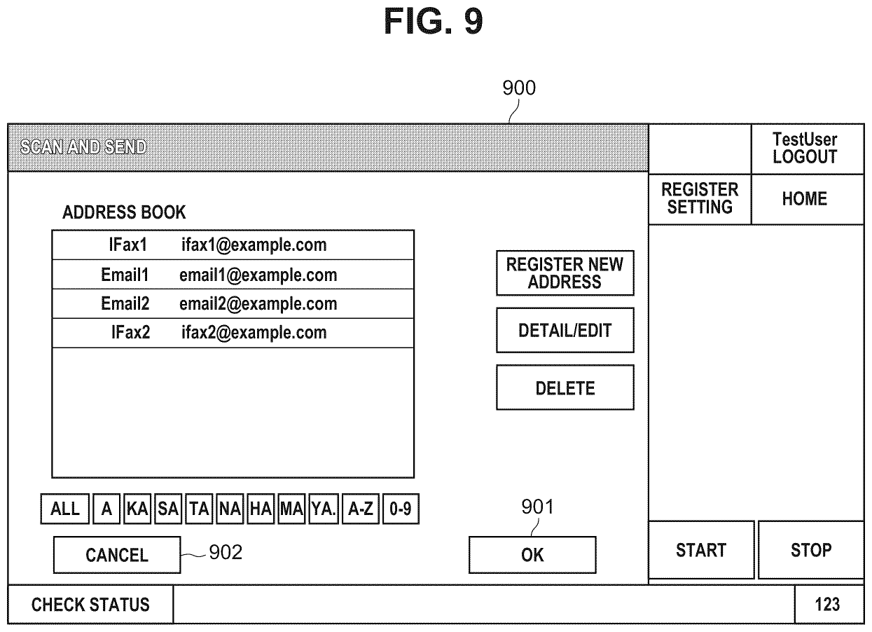

Hereinafter, the processing for selecting/confirming a transmission address for the scan and send application is described with reference to FIGS. 8 and 9.

FIG. 8 is a flowchart illustrating the processing for selecting/confirming a transmission address for the scan and send application.

In step S801, the operation display unit 220 detects a press of the button for opening an address book. In the present exemplary embodiment, a transmission address is selected from the addresses previously registered in the address book. However, a transmission address may be input directly.

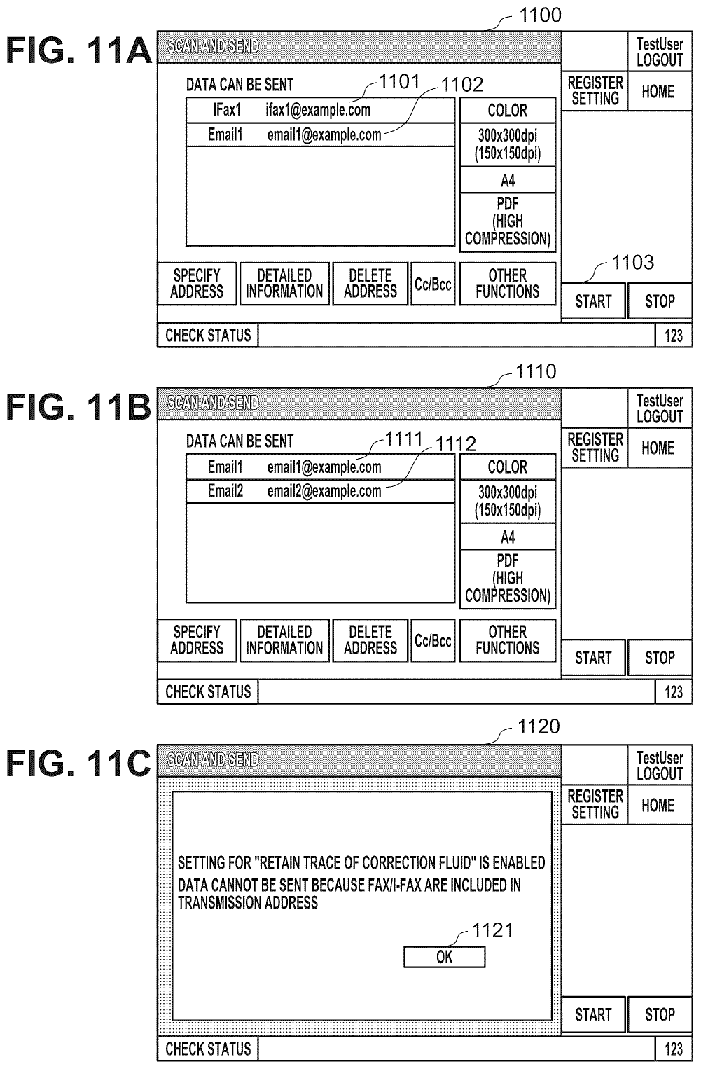

In step S802, the operation display unit 220 displays an address book screen. In a case where the user presses the address book button 411 on the scan and send screen 410 to display the address book screen, all of the addresses are displayed in unselected states. On the other hand, in a case where the user presses a button “Specify Address” displayed on a basic screen of the scan and send application (described below in FIGS. 11A and 11B) to display the address book screen, the address already set as a transmission address prior to the start of the processing in this flowchart is brought into a selected state. When the processing in step S802 ends, the processing proceeds to step S803.

An example of the address book screen displayed when the button for opening the address book is pressed is illustrated in FIG. 9. This address book screen is displayed when the address book button in FIG. 4B is pressed. It is assumed that, on the address book screen, the address selected and brought into a selected state is displayed to the user in an emphasized manner. In FIG. 9, the address displayed on the address book screen is not selected (i.e., the user opens the address book without selecting the address).

In step S803, the operation display unit 220 detects a press of the button displayed on the address book screen. Thereafter, the processing proceeds to step S804.

In a case where the operation display unit 220 determines that a pressed button is an address button in step S804 (YES in step S804), and further determines that the address corresponding to the pressed address button is in an unselected state in step S805 (YES in step S805), the processing proceeds to step S806. In step S806, the operation display unit 220 brings the selected address in a selected state. Then, the processing proceeds to step S803.

In a case where the operation display unit 220 determines that a pressed button is an address button in step S804 (YES in step S804), and further determines that the address corresponding to the pressed address button is in a selected state in step S805 (NO in step S805), the processing proceeds to step S807. In step S807, the operation display unit 220 brings the selected address into an unselected state. Then, the processing proceeds to step S803. It is assumed that, on the address book screen, the address released from a selected state is displayed to the user by bringing the address displayed in an emphasized manner back to the original state.

In step S808, in a case where the operation display unit 220 determines that a pressed button is the OK button (i.e., the OK button is pressed) (“OK BUTTON” in step S808), the processing proceeds to step S809. In step S809, the operation display unit 220 sets (adds) all of the selected addresses to the transmission addresses. Thereafter, the processing proceeds to step S810.

In step S808, in a case where the operation display unit 220 determines that a pressed button is the cancel button (i.e., the cancel button is pressed) (“CANCEL BUTTON” in step S808), the processing proceeds to step S810.

In step S810, the operation display unit 220 cancels the selected states of all of addresses. In other words, the operation display unit 220 brings all of the addresses into the unselected states. Then, the operation display unit 220 closes the address book screen, and displays the basic screen of the scan and send application (described below in FIGS. 11A and 11B). Then, the processing in this flowchart ends.

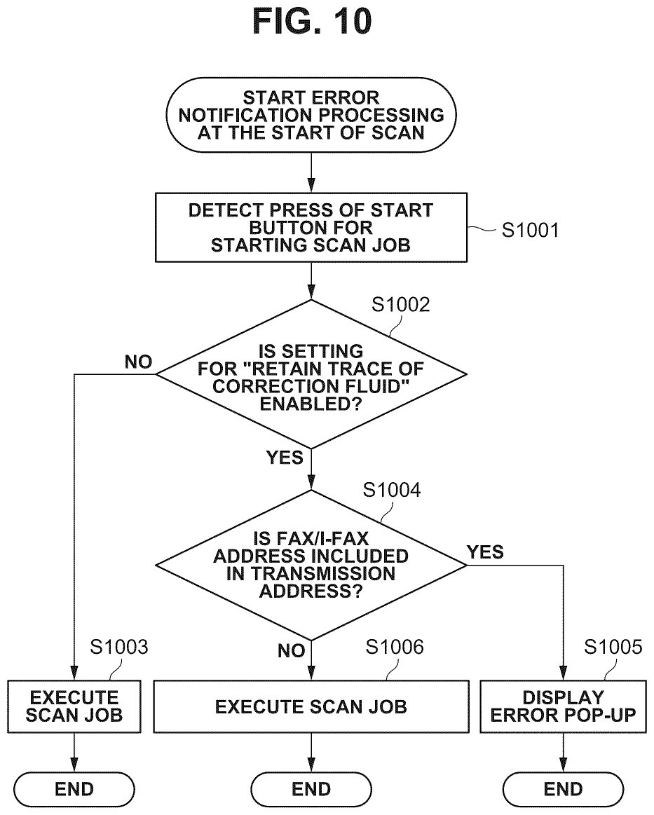

Hereinafter, error notification processing executed at the start of scan is described with reference to FIG. 10 and FIGS. 11A to 11C.

FIG. 10 is a flowchart illustrating the error notification processing executed at the start of scan.

In step S1001, the job execution button control unit 307 detects a press of a start button for starting a scan job. When a press of the start button is detected, the processing proceeds to step S1002.

FIGS. 11A and 11B are diagrams illustrating examples of the basic screen of the scan and send application displayed after the transmission address is selected in the address book screen in FIG. 9.

In FIG. 11A, transmission addresses 1101 and 1102 and a start button 1103 are displayed on the basic screen 1100, and a FAX/I-FAX address is included in the transmission addresses 1101 and 1102.

A button the user presses to start the scan job in step S1001 may be the start button 1103 displayed on the basic screen 1100 or a start button provided as a hard key (not illustrated). In FIG. 11B, transmission addresses 1111 and 1112 are displayed on the basic screen 1100, and a FAX/I-FAX address is not included in the transmission addresses 1111 and 1112.

In step S1002, in a case where the setting for “Retain Trace of Correction Fluid” is disabled (NO in step S1002), the processing proceeds to step S1003. In step S1003, the CPU 211 executes the scan job and ends the processing illustrated in this flowchart. Further, in a case where the setting for “Retain Trace of Correction Fluid” is enabled (YES in step S1002), and a FAX/I-FAX address is not included in the transmission address (NO in step S1004), the processing proceeds to step S1006. In step S1006, the CPU 211 executes the scan job and ends the processing illustrated in this flowchart.

On the other hand, in a case where a determination result acquired in step S1002 is “YES” (YES in step S1002), and one or more FAX/I-FAX addresses are included in the transmission addresses (YES in step S1004), the processing proceeds to step S1005. In step S1005, the screen display control unit 301 displays an error pop-up and ends the processing illustrated in this flowchart. An example of the error pop-up displayed at the time of transmission is illustrated in FIG. 11C. In a case where the user presses an OK button 1121, the screen display control unit 301 closes the error pop-up.

The FAX/I-FAX is a fax function for transmitting a binarized document, and a trace of a correction fluid may not be accurately retained in the binarized document. Therefore, in the present exemplary embodiment, it is assumed that execution of a job is stopped in a case where the FAX/I-FAX address is included in the transmission address of the scan data as illustrated in FIG. 11A, even if the setting for “Retain Trace of Correction Fluid” is enabled.

As described above, according to the present exemplary embodiment, the MFP 101 allows the user to implement the setting for retaining a trace of a correction fluid by only pressing the retain trace of correction fluid button 431. Then, the MFP 101 can display changed setting values to the user by reflecting the changed setting values to the color selection screen 600 (FIG. 6A), the file format screen 610 (FIG. 6B), and the density setting screen 430 (FIG. 6C). Therefore, before the job is executed, the user can confirm (figure out) the setting contents of the job to be executed. In addition, the MFP 101 may collectively notify the changed setting values by using a pop-up screen.

Further, in the above-described exemplary embodiment, after the retain trace of correction fluid button 431 is pressed, the MFP 101 displays the setting screen related to the setting for “Retain Trace of Correction Fluid” in a state where the setting values are not changeable. Therefore, the MFP 101 can reduce a possibility of the user unintentionally disabling the setting for “Retain Trace of Correction Fluid” which is intentionally set.

Further, in the above-described exemplary embodiment, in a case where the user selects a FAX/I-FAX address as a transmission address to execute job transmission after pressing the retain trace of correction fluid button 431, the MFP 101 displays the error pop-up. In this way, the MFP 101 can let the user know the correction mark cannot be retained if document data is transmitted to the FAX/I-FAX address.

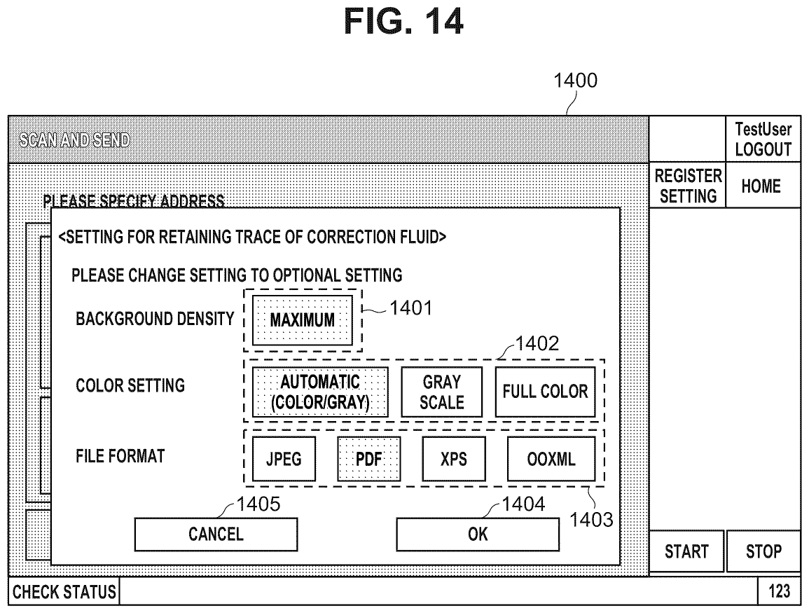

In the above-described present exemplary embodiment, a setting value of a related setting item is changed to a specific setting value in a case where the retain trace of correction fluid button 431 is pressed. However, the present exemplary embodiment is not limited thereto. For example, in a case where the related setting item has a plurality of selectable setting value candidates, the MFP 101 may prompt the user to select the setting value. Specifically, the MFP 101 may display a screen for allowing the user to select a setting value (e.g., a screen illustrated in FIG. 14 described below) on the operation display unit 220.

In the first exemplary embodiment, the retain trace of correction fluid button 431 is arranged on the density setting screen 430. In a second exemplary embodiment, a retain trace of correction fluid button is similarly arranged on each of the setting screens for the setting items related to the setting for “Retain Trace of Correction Fluid”. Specifically, the retain trace of correction fluid button is arranged on each of the color selection screen and the file format screen.

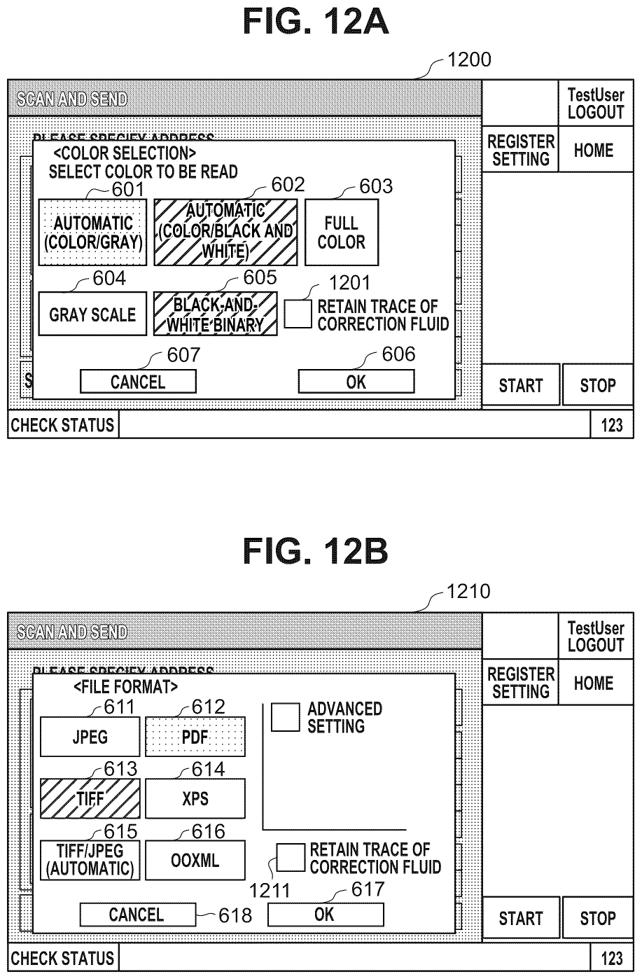

FIGS. 12A and 12B are diagrams illustrating examples of the color selection screen and the file format screen on which the retain trace of correction fluid button is arranged. Each of the screens in FIGS. 12A and 12B is displayed on the operation display unit 220 by the screen display control unit 301.

FIG. 12A illustrates an example of a color selection screen 1200 according to the present exemplary embodiment.

A retain trace of correction fluid button 1201 is arranged on the color selection screen 1200, in addition to the buttons similar to the buttons arranged on the color selection screen 600 in FIG. 6A. In a case where the user presses the retain trace of correction fluid button 1201, processing similar to the processing illustrated in the flowchart in FIG. 5 is executed.

FIG. 12B illustrates an example of a file format screen 1210 according to the present exemplary embodiment. A retain trace of correction fluid button 1211 is arranged on the file format screen 1210 in addition to the buttons similar to the buttons arranged on the file format screen 610. In a case where the user presses the retain trace of correction fluid button 1211, processing similar to the processing illustrated in the flowchart in FIG. 5 is executed.

In addition, processing different from the processing executed when the retain trace of correction fluid button 431 is pressed may be executed when each of the retain trace of correction fluid buttons 1201 and 1211 is pressed.

As described above, according to the present exemplary embodiment, the retain trace of correction fluid button is similarly displayed on each of the setting screens for the setting items related to the setting for “Retain Trace of Correction Fluid”.

In this way, the user is more likely to be aware of the presence of the retain trace of correction fluid button, so that a possibility of the user utilizing the retain trace of correction fluid function can be increased.

In the present exemplary embodiment, the retain trace of correction fluid button is arranged on each of the density setting screen, the color selection screen, and the file format screen. However, the retain trace of correction fluid button may be displayed on at least any one of the density setting screen, the color selection screen, and the file format screen.

In the first exemplary embodiment, after the setting values of the setting items related to the setting for “Retain Trace of Correction Fluid” are changed to specific values through the processing illustrated in the flowchart in FIG. 5, the user has to display each of the setting screens to confirm the values in order to confirm the changed contents again. In a third exemplary embodiment, a screen (i.e., related setting contents list screen) which allows the user to collectively confirm the change of setting contents is displayed. The related setting contents list screen can collectively display the setting values set to the plurality of related setting items.

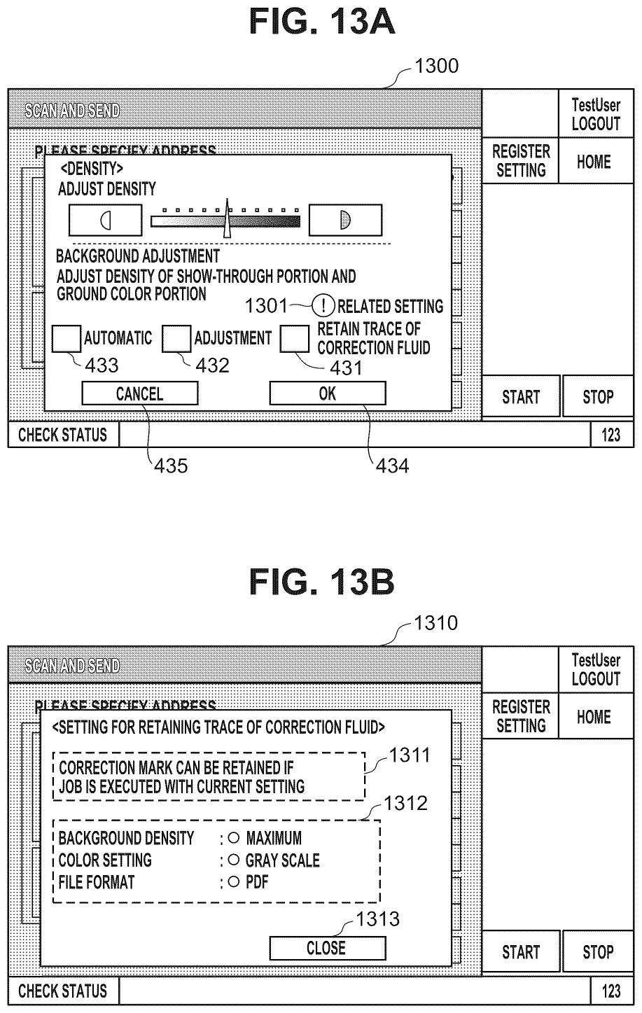

FIG. 13A is a diagram illustrating an example of the density setting screen according to the present exemplary embodiment, and FIG. 13B is a diagram illustrating an example of the related setting contents list screen additionally displayed in the present exemplary embodiment. Each of the screens illustrated in FIGS. 13A and 13B is displayed on the operation display unit 220 by the screen display control unit 301.

FIG. 13A illustrates an example of a density setting screen 1300 according to the present exemplary embodiment. A correction mark-related setting information display button 1301 is arranged on the density setting screen 1300 in addition to the buttons arranged on the density setting screen 430 in FIG. 4D. When the user presses the correction mark-related setting information display button 1301, the screen display control unit 301 displays a correction mark-related setting contents list screen described below in FIG. 13B on the operation display unit 220.

FIG. 13B illustrates an example of the correction mark-related setting contents list screen. In addition, dashed frames in FIG. 13B are illustrated for the sake of description and not actually displayed on the operation display unit 220. A correction mark setting display region 1311 for displaying a message describing whether the setting for “Retain Trace of Correction Fluid” is enabled, a setting value display region 1312 for displaying the setting values currently set to the setting items related to the setting for “Retain Trace of Correction Fluid”, and a close button 1313 for closing the correction mark-related setting contents list screen 1310 are arranged on the correction mark-related setting contents list screen 1310. The correction mark setting display region 1311 displays a message describing whether it is possible to retain a trace of a correction fluid based on a combination of the setting values currently set to the setting items related to the setting for “Retain Trace of Correction Fluid”. For example, as illustrated in FIG. 13B, a message describing that a trace of a correction fluid can be retained, e.g., “CORRECTION MARK CAN BE RETAINED IF JOB IS EXECUTED WITH CURRENT SETTING”, is displayed in a case where a trace of a correction fluid can be retained. The setting value display region 1312 displays the setting values currently set to the setting items related to the setting for “Retain Trace of Correction Fluid”. In the present exemplary embodiment, whether a trace of a correction fluid can be retained with the setting values set to the setting items is indicated by a noughts-and-crosses display method using symbols “o” and “x”. For example, a symbol “o” is displayed with respect to a setting value by which a trace of a correction fluid can be retained, whereas a symbol “x” is displayed with respect to a setting value by which a trace of a correction fluid cannot be retained. Further, for example, in a case where at least one setting value is a setting value with which a trace of a correction fluid cannot be retained, (i.e., on which the symbol “x” is displayed), a message indicating that a trace of a correction fluid cannot be retained may be displayed in the correction mark setting display region 1311. Further, in the present exemplary embodiment, only the setting items related to the setting for “Retain Trace of Correction Fluid”, which the user can change the setting, are displayed in the setting value display region 1312. However, information about the setting items which the user cannot change the setting may also be displayed in the setting value display region 1312.

As described above, according to the present exemplary embodiment, a screen which allows the user to collectively confirm the change of setting contents, i.e., the related setting contents list screen, is displayed. Through the above-described screen, the user can easily figure out the current setting because contents of setting values currently set to the setting items related to the setting for “Retain Trace of Correction Fluid” can be confirmed at one time (collectively). Therefore, it is possible to reduce a possibility of the user executing a job with the setting not desired by the user.

In the present exemplary embodiment, the correction mark-related setting information display button 1301 is displayed on the density setting screen. However, the present exemplary embodiment is not limited thereto. For example, the correction mark-related setting information display button 1301 may also be displayed on the color selection screen and the file format screen. Further, the correction mark-related setting information display button 1301 may be displayed on at least any one of the density setting screen, the color selection screen, and the file format screen.

In the first exemplary embodiment, in a case where the operation for enabling the setting for “Retain Trace of Correction Fluid” is performed, the change of setting contents confirmation pop-up 440 is displayed in step S503 illustrated in the flowchart in FIG. 5, so that the user is notified of a message describing change of the setting contents. In a fourth exemplary embodiment, instead of displaying the change of setting contents confirmation pop-up 440, a setting screen which allows the user to make change on the related setting items (i.e., the setting values set to the plurality of related setting items) is displayed.

FIG. 14 is a diagram illustrating an example of a related setting item one-time setting screen 1400, which allows the user to set setting items related to the setting for retaining a trace of a correction fluid, according to the present exemplary embodiment. The screen 1400 in FIG. 14 is displayed on the operation display unit 220 by the screen display control unit 301. In addition, dashed frames in FIG. 14 are illustrated for the sake of description and not actually displayed on the operation display unit 220. Regions 1401 to 1403 for displaying setting value selection buttons, an OK button 1404 for closing the screen 1400 after reflecting the change of setting input to the screen 1400, and a cancel button 1405 for closing the screen 1400 without reflecting the change of setting are arranged on the related setting item one-time setting screen 1400. In the present exemplary embodiment, a background density setting region 1401, a color setting region 1402, and a file format setting region 1403 are arranged as the regions for displaying the setting value selection buttons. Further, buttons corresponding to the setting value candidates not competing with the setting for retaining a trace of a correction fluid (i.e., the setting value which does not cancel or disable the setting for retaining a trace of a correction fluid) are displayed in the setting regions 1401, 1402, and 1403. For example, with respect to the background density, only “Maximum” is the setting value which enables the setting for retaining a trace of a correction fluid. Therefore, the maximum button is displayed as a fixed value. With respect to the color setting, a setting value of “Black-and-White Binary” is not displayed because the setting value competes with the setting for retaining a trace of a correction fluid (i.e., because the setting value cancels or disables the setting for retaining a trace of a correction fluid). Therefore, in the region 1402, setting values other than the setting value of “Black-and-White Binary”, i.e., setting values of “Gray Scale” and “Full Color”, are displayed as the setting value candidates. With respect to the file format setting, a setting value of “TIFF” is not displayed because the setting value competes with the setting for retaining a trace of a correction fluid. Therefore, in the region 1403, setting values of “JPEG”, “XPS”, and “OOXML” which do not compete with the setting for retaining a trace of a correction fluid are displayed as the setting value candidates.

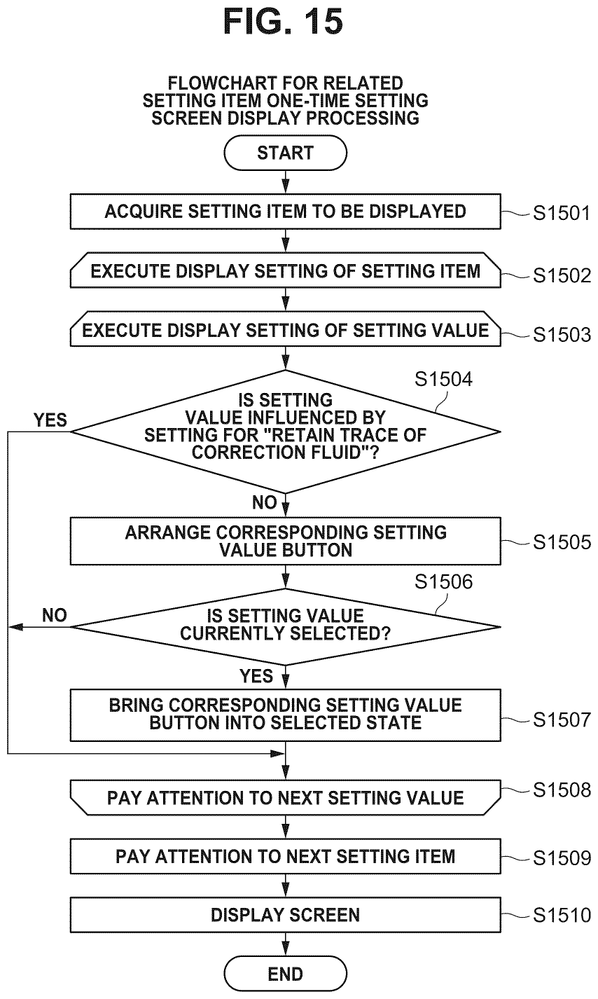

FIG. 15 is a flowchart illustrating an example of processing for displaying the related setting item one-time setting screen 1400. The CPU 211 of the MFP 101 executes the processing illustrated in the flowchart in FIG. 15 by reading a program for executing the control module stored in the ROM 212 to the RAM 213 and executing the program. In addition, all or a part of the functions executed in respective steps in FIG. 15 may be executed by hardware such as an ASIC or an electronic circuit.

The processing illustrated in the flowchart in FIG. 15 is started when the user presses the retain trace of correction fluid button 431 displayed on the density setting screen 430 in FIG. 4D.

In step S1501, the screen display control unit 301 acquires a group of setting items related to the setting for “Retain Trace of Correction Fluid”, which are to be displayed on the related setting item one-time setting screen 1400, from the RAM 213.

In step S1502, the screen display control unit 301 pays attention to one of the setting items acquired in step S1501.

In step S1503, the screen display control unit 301 pays attention to one of the setting value candidates of the setting item to which attention is paid in step S1502.

In step S1504, the screen display control unit 301 determines whether the setting value candidate, to which attention is paid in step S1503, is a setting value influenced by the setting for “Retain Trace of Correction Fluid”. At this time, the screen display control unit 301 determines whether the setting value is influenced by the setting for retaining a trace of a correction fluid based on the above-described Table 1. In a case where a determination result acquired in step S1504 is “YES” (YES in step S1504), the screen display control unit 301 advances the processing to step S1508 without arranging the setting value button corresponding to the setting value candidate to which attention is paid in step S1503. In a case where a determination result acquired in step S1504 is “NO” (NO in step S1504), the processing proceeds to step S1505.

In step S1505, the screen display control unit 301 arranges the setting value button corresponding to the setting value candidate to which attention is paid in step S1503 on the related setting item one-time setting screen 1400. The corresponding setting value button is arranged in a setting region corresponding to the setting item to which attention is paid in step S1502. For example, in FIG. 14, the setting value button is arranged in any one of the background density setting region 1401, the color setting region 1402, and the file format setting region 1403.

In step S1506, the screen display control unit 301 determines whether the setting value candidate to which attention is paid in step S1503 has already been selected (set). At this time, the screen display control unit 301 acquires information indicating whether the setting value candidate has already been selected from the RAM 213. In a case where a determination result acquired in step S1506 is “YES” (YES in step S1506), the processing proceeds to step S1507. In a case where a determination result acquired in step S1506 is “NO” (NO in step S1506), the processing proceeds to step S1508.

In step S1507, the screen display control unit 301 brings the button corresponding to the setting value candidate to which attention is paid, which is arranged on the related setting item one-time setting screen 1400, into a selected state. Thereafter, the processing proceeds to step S1508.

In step S1508, from among the setting value candidates of the setting item to which attention is paid in step S1502, the screen display control unit 301 pays attention to the setting value candidate to which attention has not been paid yet. Then, the processing proceeds to step S1503. At this time, in a case where there is no setting value candidate to which attention has not yet been paid, the processing proceeds to step S1509.

In step S1509, the screen display control unit 301 pays attention to the setting item to which attention has not been paid yet from among the group of setting items acquired in step S1501. Then the processing proceeds to step S1502. At this time, in a case where there is no setting item to which attention has not yet been paid, the processing proceeds to step S1510.

In step S1510, the screen display control unit 301 displays the related setting item one-time setting screen 1400 on the operation display unit 220, and ends the processing illustrated in this flowchart.

As described above, according to the present exemplary embodiment, in a case where the operation for enabling the setting for “Retain Trace of Correction Fluid” is performed, a setting screen (related setting item one-time setting screen) which allows the user to change the setting items related to the setting for retaining a trace of a correction fluid is displayed. In this way, the user can collectively confirm the current states of the setting items related to the setting for “Retain Trace of Correction Fluid”. Further, in a case where the setting is different from the setting intended by the user, the user can adjust or change the setting through the related setting item one-time setting screen displayed thereon. Therefore, it is possible to reduce a possibility of the user executing a job with the setting not desired by the user.

Further, in the present exemplary embodiment, the setting value buttons corresponding to the setting value candidates are displayed on the related setting item one-time setting screen 1400. However, the present exemplary embodiment is not limited thereto. For example, a button which allows the user to make the related setting item one-time setting screen 1400 transition to a setting screen (e.g., the color selection screen 600) of the setting item related to the setting for retaining a trace of a correction fluid may be displayed on the related setting item one-time setting screen 1400.

Further, according to the present exemplary embodiment, the related setting item one-time setting screen 1400 is displayed instead of the change of setting contents confirmation pop-up 440 when the retain trace of correction fluid button 431 is pressed. However, the present exemplary embodiment is not limited thereto. For example, the related setting item one-time setting screen 1400 may be displayed instead of the correction mark-related setting contents list screen 1310 displayed in the third exemplary embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-014586, filed Feb. 2, 2024, which is hereby incorporated by reference herein in its entirety.

What is claimed is:

1. An image processing apparatus comprising:
at least one memory that stores a set of instructions; and
at least one processor that executes the instructions causing the image processing apparatus to perform operations comprising:
a generation unit configured to generate document data based on a read document;
a setting unit configured to enable a correction mark setting which causes a correction mark indicating a trace of a correction made to the document to be included in the document data generated by the generation unit; and
a display unit configured to display a setting screen of a setting related to the correction mark setting,
wherein, in a case where the setting screen of the setting related to the correction mark setting is displayed by the display unit while the correction mark setting is being enabled, the setting screen of the setting related to the correction mark setting is displayed in a state where a setting value for enabling the correction mark setting is selected.

2. The image processing apparatus according to claim 1, wherein, in a case where an operation for enabling the correction mark setting is received, the display unit displays a screen indicating that a setting value of the setting related to the correction mark setting is set to the setting value for enabling the correction mark setting.

3. The image processing apparatus according to claim 1, wherein, in the setting screen of the setting related to the correction mark setting, a setting value for disabling the correction mark setting is displayed in a non-selectable state.

4. The image processing apparatus according to claim 2, wherein the operation for enabling the correction mark setting is an operation for selecting a button for enabling the correction mark setting, the button for enabling the correction mark setting being displayed on a setting screen related to a density setting.

5. The image processing apparatus according to claim 1, wherein the setting related to the correction mark setting is at least any one of a color setting, a file format setting, and a density setting.

6. The image processing apparatus according to claim 1, further comprising a control unit configured to execute a function for transmitting the document data generated by the generation unit.

7. The image processing apparatus according to claim 6, wherein, in a case where an address set for the function for transmitting the document data is an address of a fax function, the display unit displays a screen indicating that the function for transmitting the document data is not executed.

8. The image processing apparatus according to claim 1, wherein a button for enabling the correction mark setting is displayed on at least any one of a screen related to a color setting, a screen related to a file format setting, and a screen related to a density setting.

9. The image processing apparatus according to claim 1, wherein, in a case where a button for displaying a predetermined screen capable of collectively displaying setting values of a plurality of settings related to the correction mark setting is pressed, the display unit displays the predetermined screen.

10. The image processing apparatus according to claim 1, wherein, in a case where an operation for enabling the correction mark setting is received, the display unit displays a specific screen capable of changing setting values of a plurality of settings related to the correction mark setting.

11. The image processing apparatus according to claim 10, wherein the specific screen is displayed in a state where setting values for enabling the correction mark setting are selected with respect to the plurality of settings related to the correction mark setting.

12. A control method of an image processing apparatus comprising:
generating document data based on a read document;
executing setting for enabling a correction mark setting which causes a correction mark indicating a trace of a correction made to the document to be included in the document data generated by the generating; and
displaying a setting screen of a setting related to the correction mark setting,
wherein, in a case where the setting screen of the setting related to the correction mark setting is displayed by the displaying while the correction mark setting is being enabled, the setting screen of the setting related to the correction mark setting is displayed in a state where a setting value for enabling the correction mark setting is selected.

13. A non-transitory computer-readable storage medium storing a program for causing the image processing apparatus according to claim 1 to function.
